(19) United States
(12) Patent Application Publication
(10) Pub. No.: US 2018/0082675 A1
(43) Pub. Date: Mar. 22, 2018

(54) TEXT-TO-SPEECH METHOD AND SYSTEM

(71) Applicant: MStar Semiconductor, Inc., Hsinchu Hsien (TW)

(72) Inventor: Sung-Wen Wang, Hsinchu Hsien (TW)

(21) Appl. No.: 15/485,322

(22) Filed: Apr. 12, 2017

(30) Foreign Application Priority Data
Sep. 19, 2016 (TW) 105130180

(51) Int. Cl. G10L 13/10; G10L 13/06; G10L 13/04

(52) U.S. Cl. CPC G10L 13/10; G10L 13/04; G10L 13/06

(57) ABSTRACT

A text-to-speech method includes: receiving a text series, and generating a plurality of phonemes corresponding to the text series, wherein the phonemes form a phoneme series; inserting a pause phoneme into the phoneme series; dividing the phoneme series and the pause phoneme into a plurality of phoneme sub-series by using the pause phoneme as a dividing point, and generating a plurality of speech segments according to the phoneme sub-series; and performing a speech synthesis operation individually on the speech segments to generate a plurality of speech outputs corresponding to the plurality of speech segments. The pause phoneme is a last phoneme of the phoneme sub-series in which the pause phoneme locates.

This application claims the benefit of Taiwan application Serial No. 105130180, filed Sep. 19, 2016, the subject matter of which is incorporated herein by reference.

### BACKGROUND OF THE INVENTION

### Field of the Invention

The invention relates in general to a text-to-speech method and a text-to-speech system, and more particularly to a text-to-speech method and a text-to-speech system that reduce the amount of computation for speech synthesis and enhance the quality of speech synthesis.

### Description of the Related Art

One main function of a text-to-speech (TTS) system is converting text inputted into a natural and smooth speech output, and is extensively applied in the daily life. For example, a text-to-speech system is applicable to public intercoms in stations, airports and schools, automatic name (or number) calling systems in hospitals or courts, or even the manufacture of audio books to reduce production costs of audio books. Among numerous text-to-speech technologies, a hidden Markov model based (HMM-based) speech synthesis technology is widely adopted in the related field.

In the HMM-based speech synthesis technology, a text series is first completely analyzed, and acoustic parameters associated with the text series, such as excitation parameters or spectra parameters, are then generated according to the analysis result. Thus, the conventional HMM-based speech synthesis technology requires immense amount of computation and memory space, which disfavor the application of real-time speech synthesis. Further, if a text series (or a corresponding phoneme series) is divided, abruptness and discontinuity may be produced in the synthesized speech. In fact, a popping sound is produced at a dividing point of the synthesized speech, which may then sound discontinuous, hence rendering degraded speech synthesis quality.

Therefore, there is a need for a solution that reduces the amount of computation required for speech synthesis and enhances the quality of speech synthesis.

### SUMMARY OF THE INVENTION

The invention is directed to a text-to speech method and a text-to-speech system that reduce the amount of computation required for speech synthesis and enhance the quality of speech synthesis to improve the issues of the prior art.

The present invention discloses a text-to-speech method. The method includes: receiving a text series, and generating a plurality of phonemes corresponding to the text series, wherein the phonemes form a phoneme series; inserting at least one pause phoneme into the phoneme series; dividing the phoneme series and the at least one pause phoneme into a plurality of phoneme sub-series by using the at least one pause phoneme as a dividing point, and generating a plurality of speech segments according to the phoneme sub-series, wherein each of the speech segments includes a plurality of text labels that include a relationship of the plurality of phonemes; and performing a speech synthesis operation individually on the speech segments to generate a plurality of speech outputs corresponding to the plurality of speech segments. The at least one pause phoneme is a last phoneme of the phoneme sub-series in which the pause phoneme locates.

The present invention further discloses a text-to-speech system. The system includes: a phoneme generator, receiving a text series, and generating a plurality of phonemes corresponding to the text series, wherein the plurality of phonemes form a phoneme series; a pause phoneme inserter, inserting at least one pause phoneme into the phoneme series; a divider, dividing the phoneme series and the at least one pause phoneme into a plurality of phoneme sub-series by using the at least one pause phoneme as a dividing point, and generating a plurality of speech segments according to the plurality of phoneme sub-series, wherein each of the speech segments includes a plurality of text labels that include a relationship of the plurality of phonemes; and a speech synthesizer, performing a speech synthesis operation individually on the plurality of speech segments to generate a plurality of speech outputs corresponding to the plurality of speech segments. The at least one pause phoneme inserted is a last phoneme of the phoneme sub-series in which the at least one pause phoneme locates.

The present invention further discloses a text-to-speech system. The system includes: a processing circuit; and a storage circuit, coupled to the storage circuit, storing a program code. The program code instructs the processing circuit to perform steps of: receiving a text series, and generating a plurality of phonemes corresponding to the text series, wherein the plurality of phonemes form a phoneme series; inserting at least one pause phoneme into the phoneme series; dividing the phoneme series and the at least one pause phoneme into a plurality of phoneme sub-series by using the at least one pause phoneme as a dividing point, and generating a plurality of speech segments according to the phoneme sub-series, wherein each of the speech segments includes a plurality of text labels that include a relationship of the plurality of phonemes; and performing a speech synthesis operation individually on the speech segments to generate a plurality of speech outputs corresponding to the plurality of speech segments. The at least one pause phoneme is a last phoneme of the phoneme sub-series in which the pause phoneme locates.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a text-to-speech system according to an embodiment of the present invention;

FIG. 2 is a flowchart of a text-to-speech method according to an embodiment of the present invention;

FIG. 3 is a schematic diagram of a phoneme series, a plurality of pause phonemes and a plurality of speech segments according to an embodiment of the present invention;

FIG. 4 is a flowchart of a speech synthesis method according to an embodiment of the present invention; and

FIG. 5 is a block diagram of a text-to-speech system according to an embodiment of the present invention.

### DETAILED DESCRIPTION OF THE INVENTION

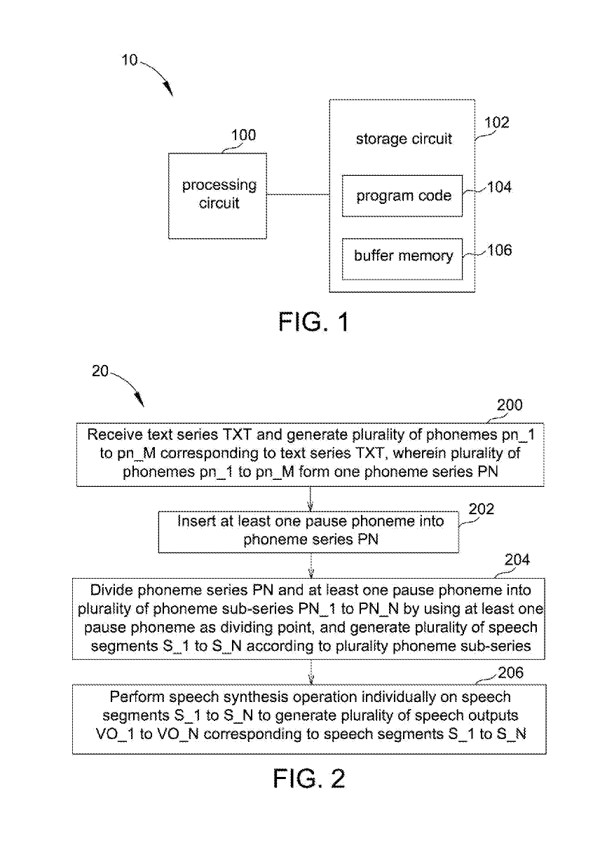

To overcome the issues of the prior art, in the present invention, a pause phoneme is inserted into a text series, and the text series is divided by using the pause phoneme as a dividing point and is processed in different batches and/or at different times to reduce the requirements on the amount of computation and memory space. Meanwhile, the sense of discontinuity caused by abrupt interrupts in a speech is eliminated to enhance the quality of speech synthesis. FIG. 1 shows a block diagram of a text-to-speech system 10 according to an embodiment of the present invention. More specifically, the text-to-speech system 10 includes a processing circuit 100 and a storage circuit 102. The processing circuit 100, coupled to the storage circuit 102, may be a general-purpose processor, e.g., a central processing unit (CPU) or a microprocessor. The storage circuit 102, which may be a read-only memory (ROM), or a non-volatile memory, e.g., an electrically erasable programmable read-only memory (EEPROM) or a flash memory, stores a program code 106. The program code 106 instructs the processing circuit 100 to perform a text-to-speech process. Further, the storage circuit 102 includes a buffer memory 106, which serves as a buffer during speech synthesis.

FIG. 2 shows a flowchart of a text-to-speech method 20 according to an embodiment of the present invention. The text-to-speech method 20 may be performed by the text-to-speech system 10, and includes following steps.

In step 200, a text series TXT is received, and a plurality of phonemes pn_1 to pn_M corresponding to the text series TXT are generated. The phonemes pn_1 to pn_M form a phoneme series PN.

In step 202, at least one pause phoneme is inserted into the phoneme series PN.

In step 204, by using the at least one pause phoneme as a dividing point, the phoneme series PN and the at least one pause phoneme are divided into a plurality of phoneme sub-series PN_1 to PN_N, and a plurality of speech segments S_1 to S_N are generated according to the phoneme sub-series PN_1 to PN_N.

In step 206, a speech synthesis operation is performed individually on the speech segments P_1 to P_N to generate a plurality of speech outputs VO_1 to VO_N corresponding to the speech segments S_1 to S_N.

Details of the text-to-speech method 20 are given below. In step 200, the text-to-speech system 10 receives the text series TXT, and generates the plurality of phonemes pn_1 to pn_M corresponding to the text series TXT. The text series TXT may be a paragraph of an article, or may be a long article including multiple paragraphs. In other words, the text series TXT is formed by a large number of characters (or words) and punctuations. More specifically, the text-to-speech system 10 converts each word in the text series TXT to a corresponding sound phoneme, or converts the punctuations in the text series TXT into pause phonemes. Further, the text-to-speech system 10 arranges the sound phonemes corresponding to words and the pause phonemes corresponding to punctuations in an appropriate order to form a phoneme series PN. The phonemes pn_1 to pn_M may be sound phonemes or pause phonemes.

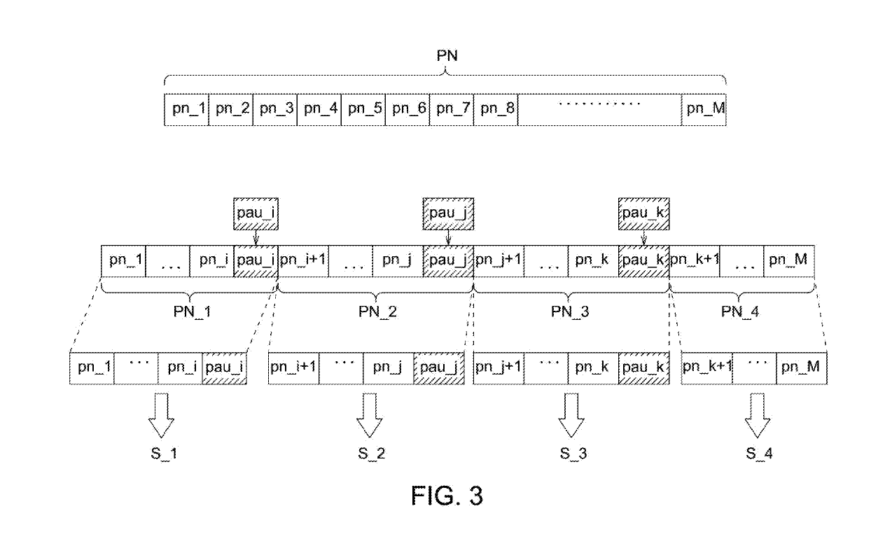

In step 202, the text-to-speech system 10 inserts at least one pause phoneme into the phoneme series PN. In step 204, by using the at least one pause phoneme as a dividing point, the phoneme series PN is divided to generate the plurality of speech segments S_1 to S_N. For example, the text-to-speech system 10 may insert pause a phonemes pau_i, a pause phoneme pau_j and a pause phoneme pau_k among the phonemes pa_1 to pn_M (taking inserting three pause phonemes for instance), divide the phoneme series PN into phoneme sub-series PN_1 to PN_4 by using the phonemes pau_i, the pause phoneme pau_j and the pause phoneme pau_k as dividing points, and generate the speech segments S_1 to S_4 according to the phoneme sub-series PN_1 to PN_4. More specifically, refer to FIG. 3 showing a schematic diagram of the phoneme series PN, the pause phonemes pau_i, pau_j and pau_k and the speech segments S_1 to S_4. For illustration purposes, FIG. 3 depicts only the relationship of the pause phonemes pau_i, pau_j and pau_k and the phoneme series PN, while pause phonemes converted from punctuations in the text series TXT are omitted. As shown in FIG. 3, the text-to-speech system 10 may insert the pause phonemes pau_i, pau_j and pau_k into the phoneme series PN, and divide the phoneme series PN into the phoneme sub-series PN_1, the phoneme sub-series PN_2, the phoneme sub-series PN_3 and phoneme sub-series PN_4 by using the pause phonemes pau_i, pau_j and pau_k as dividing points. The phoneme series PN_1 includes the phonemes pn_1 to pn_i and the pause phoneme pau_i, the phoneme series PN_2 includes the phonemes pn_i+1 to pn_j and the pause phoneme pau_j, the phoneme series PN_3 includes the phonemes pn_j+1 to pn_k and the pause phoneme pau_, and the phoneme series PN_4 includes the phonemes pn_k+1 to pn_M. Thus, the text-to-speech system 10 may generate the speech segments S_1, S_2, S_3 and S_4 respectively according to the phoneme sub-series PN_1, PN_2, PN_3 and PN_4, and then add text labels associated with the phoneme sub-series PN_1, PN_2, PN_3 and PN_4 respectively into the speech segments S_1, S_2, S_3 and S_4. It should be noted that, the pause phonemes pau_i, pau_j and pau_k are respectively located at the ends of the phoneme sub-series PN_1, PN_2 and PN_3. In other words, taking the phoneme sub-series PN_1 for example, the pause phoneme pau_i is the last phoneme of the phoneme sub-series PN_1. Likewise, the pause phoneme pau_j is the last phoneme of the phoneme sub-series PN_2, and the pause phoneme pau_k is the last phoneme of the phoneme sub-series PN_3. It is experimentally proven that, when a pause phoneme is located at the end of a phoneme sub-series in which the pause phoneme locates, the sense of discontinuity caused by abrupt interrupts of voice signals may be alleviated.

Further, the text-to-speech system 10 may first determine the pause positions i, j and k, and insert the pause phonemes pau_i, pau_j and pau_k at the corresponding pause positions i, j and k in the phoneme series PN. In other words, the text-to-speech system 10 inserts the pause phoneme pau_i to between the phoneme pn_i and the phoneme pn_i+1, the pause phoneme pau_k to between the phoneme pn_j and the phoneme pn_j+1, and the pause phoneme pau_k to between the phoneme pn_k and the phoneme pn_k+1. How the text-to-speech system 10 determines the pause positions i, j and k is not limited to a specific approach. In one embodiment, the text-to-speech system 10 first determines whether the text series TXT includes a punctuation. If so, the text-to-speech system 10 determines a pause position as the corresponding position of the punctuation in the text series TXT. In one embodiment, the text-to-speech system 10 may determine whether the text series TXT includes a phrase (according to a database). If so, a pause phoneme is inserted to an end of the phrase. In other words, when the text-to-speech system 10 determines that the text series TXT includes a phrase, the text-to-speech system 10 determines that a pause phoneme corresponds to the end of the phrase. In one embodiment, the text-to-speech system 10 may determine a pause position g for inserting the pause phoneme to the phoneme series according to a length of the buffer memory 106, and insert a pause phoneme pau_g at the pause position g.

Further, each speech segment S_n of the speech segments S_1 to S_N includes a plurality of text labels. Text labels, generally known to one person skilled in the art, are for labeling relationships of the phonemes pn_1 to pn_M. More specifically, text labels label relationships between phonemes of words and phonemes of words (or phonemes of words and phonemes of punctuations) in the text series TXT. For example, assume that a first word and a second word are adjacent words in the text series TXT, with the first word preceding the second word. Thus, a text label labels the relationship between a rear phoneme of the first word and a front phoneme of the second word.

Further, the text-to-speech system 10 may perform step 202 and step 204 by parallel processing or by serial processing. In other words, the text-to-speech system 100 may one-time determine a plurality of pause positions (e.g., determining H pause positions all at once, where H>1), insert the H/plurality of pause phonemes into the phoneme series PN, divide the phoneme series PN to generate H+1/a plurality of speech segments (i.e., parallel processing) by using the H/plurality of pause phonemes as dividing points. Alternatively, the text-to-speech system 10 may determine a first pause position at a first time point, insert a first pause phoneme to the first pause position in the phoneme series PN, separate the first pause phoneme and a plurality of phonemes before the first pause phoneme from the phoneme series PN (the remaining phoneme series is to be referred to as a phoneme series PN′), and generate a first speech segment according to the first pause phoneme and the phonemes before the first pause phoneme. Next, the text-to-speech system 10 may determine a second pause position at a second time point, insert a second pause phoneme to the second pause position in the phoneme series PN, separate the second pause phoneme and a plurality of phonemes before the second pause phoneme from the phoneme series PN′, and generate a second speech segment according to the second pause phoneme and the phonemes before the second pause phoneme. The above process is cyclically performed (i.e., serial processing).

In step 206, the text-to-speech system 10 performs a speech synthesis operation individually on the speech segments S_1 to S_N to generate a plurality of speech outputs VO_1 to VO_N corresponding to the speech segments S_1 to S_N. At this point, the text-to-speech system 10 processes the speech segments S_1 to S_N by serial processing. In other words, the text-to-speech system 10 processes only one speech segment S_n (i.e., performing the speech synthesis operation) at a time, and processes a next speech segment S_n+1 once the speech segment S_n is completely (or substantially completely) processed.

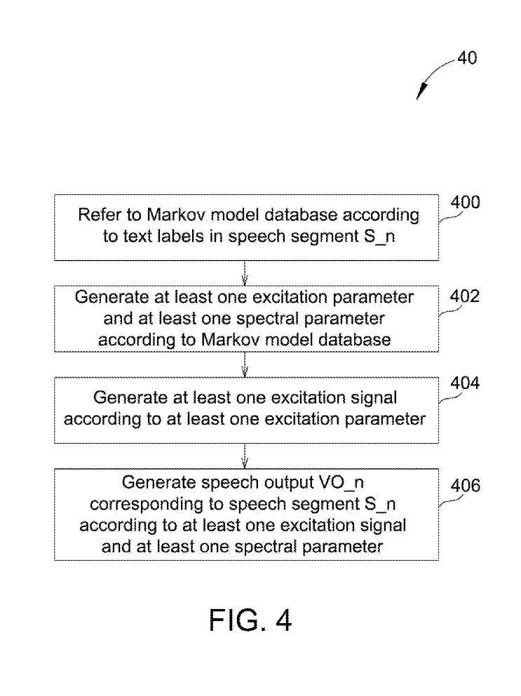

Further, the text-to-speech system 10 may adopt the hidden Markov model based (HMM-based) speech synthesis technology to perform the speech synthesis operation on the speech segment S_n to generate a speech output VO_n corresponding to the speech segment S_n. FIG. 4 shows a flowchart of a speech synthesis method according to an embodiment of the present invention. Referring to FIG. 4, the speech synthesis method 40 may be performed by the text-to-speech system 10, and includes following steps.

In step 400, a Markov model database is referred according to a text label in the speech segment S_n.

In step 402, at least one excitation parameter and at least one spectral parameter are generated according to the Markov model database.

In step 404, at least one excitation signal is generated according to the at least one excitation parameter.

In step 406, a speech output VO_n corresponding to the speech segment S_n is generated according to the at least one excitation signal and the at least one spectral parameter.

The HMM-based speech synthesis technology is generally known to one person skilled in the art. Associated details and principles may be referred from a website link: http://hts.sp.nitech.ac.jp/archives/2.3/HTS_Slides.zip, and shall be omitted herein.

As described, in the present invention, pause phonemes are inserted into the phoneme series PN, the phoneme series PN is divided to generate a plurality of speech segments S_1 to S_N by using the pause phonemes as dividing points, and a speech synthesis operation is performed individually on the speech segments S_1 to S_N to generate a plurality of speech outputs VO_1 to VO_N corresponding to the speech segments S_1 to S_N. Compared to the prior art, the present invention not only reduces the amount of computation and memory space required but also eliminates the discontinuity caused by abrupt interrupts in the speech, thereby enhancing the quality of speech synthesis.

It should be noted that, the foregoing embodiments are for explaining the concept of the present invention, and modifications may be made thereto by one person skilled in the art. For example, the text-to-speech system may insert additional punctuations in the text series TXT based on actual conditions. Thus, the punctuations that the text-to-speech inserts may be converted to pause phonemes and be inserted in the phoneme series PN.

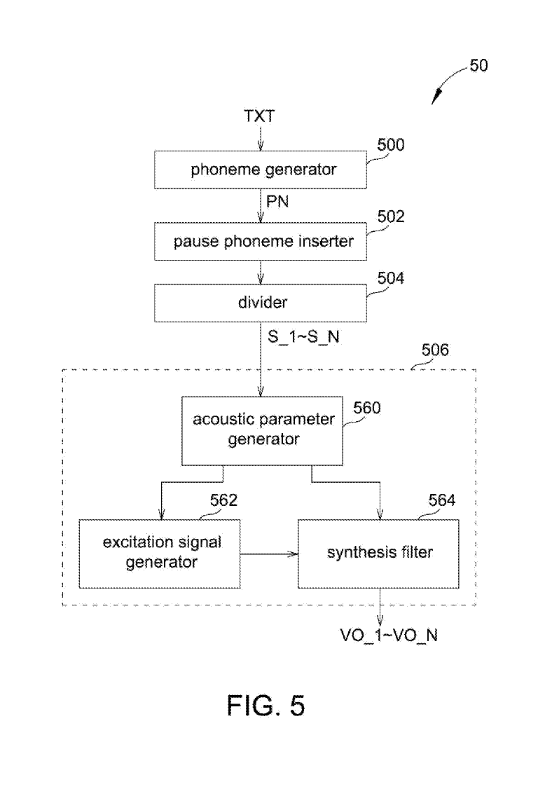

Further, the text-to-speech of the present invention is not limited to being implemented by the architecture in FIG. 1. For example, the text-to-speech system may be implemented by different function units. FIG. 5 shows a block diagram of a text-to-speech system 50 according to an embodiment of the present invention. The text-to-speech system 50 includes a phoneme generator 500, a pause phoneme inserter 502, a divider 504 and a speech synthesizer 506. The phoneme generator 500 performs step 200 of step 20, the pause phoneme inserter 502 performs step 202, the divider 504 performs step 204, and the speech synthesizer 506 performs step 206. Further, the phoneme generator 500 may insert additional punctuations into the text series TXT. Further, the speech synthesizer 506 includes an acoustic parameter generator 506, an excitation signal generator 562 and a synthesis filter 564. The acoustic parameter generator 560 performs step 400 and step 402 of step 40, the excitation signal generator 562 performs step 404, and the synthesis filter 564 performs step 406. Known to one person skilled in the art, the function units in FIG. 5 may be realized or implemented by digital logic circuits.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A text-to-speech method, comprising:
receiving a text series, and generating a plurality of phonemes corresponding to the text series, wherein the plurality of phonemes form a phoneme series;
inserting at least one pause phoneme into the phoneme series; and
dividing the phoneme series and the at least one pause phoneme into a plurality of phoneme sub-series by using the at least one pause phoneme as a dividing point, and generating a plurality of speech segments, wherein each of the speech segments comprises a plurality of text labels that comprise relationships of the plurality of phonemes;
wherein, the at least one pause phoneme is a last phoneme of the phoneme sub-series in which the at least one pause phoneme locates.

2. The text-to-speech method according to claim 1, wherein the step of inserting the at least one pause phoneme into the phoneme series comprises:
inserting a pause phoneme of the at least one pause phoneme at a corresponding punctuation in the text series.

3. The text-to-speech method according to claim 1, wherein the step of inserting the at least one pause phoneme into the phoneme series comprises:
determining a pause position of a pause phoneme of the at least one pause phoneme according to a length of a buffer memory; and
inserting the pause phoneme to the pause position.

4. The text-to-speech method according to claim 1, wherein the step of inserting the at least one pause phoneme into the phoneme series comprises:
determining whether the text series comprises a phrase; and
when the text series comprises the phrase, inserting a pause phoneme of the at least one pause phoneme to a corresponding end of the phrase.

5. The text-to-speech method according to claim 1, further comprising:
inserting a punctuation into the text series.

6. The text-to-speech method according to claim 1, further comprising:
performing a speech synthesis operation individually on the plurality of speech segments to generate a plurality of speech outputs corresponding to the speech segments.

7. The text-to-speech method according to claim 6, wherein the step of performing the speech synthesis operation individually on the plurality of speech segments to generate the plurality of speech outputs corresponding to the speech segments comprises:
generating at least one excitation parameter and at least one spectral parameter according to a first speech segment of the plurality of speech segments;
generating at least one excitation signal according to the at least one excitation parameter; and
generating a first speech output corresponding to the first speech segment according to the at least one excitation signal and the at least one spectral parameter.

8. A text-to-speech system, comprising:
a phoneme generator, receiving a text series and generating a plurality of phonemes corresponding to the text series, wherein the plurality of phonemes form a phoneme series;
a pause phoneme inserter, inserting at least one pause phoneme into the phoneme series; and
a divider, dividing the phoneme series and the at least one pause phoneme into a plurality of phoneme sub-series by using the at least one pause phoneme as a dividing point, and generating a plurality of speech segments, wherein each of the speech segments comprises a plurality of text labels that comprise relationships of the plurality of phonemes;
wherein, the at least one pause phoneme is a last phoneme of the phoneme sub-series in which the at least one pause phoneme locates.

9. The text-to-speech system according to claim 8, wherein the pause phoneme inserter inserts the at least one pause phoneme into the plurality of phonemes by further performing a step of:
inserting a pause phoneme of the at least one pause phoneme at a corresponding punctuation in the text series.

10. The text-to-speech system according to claim 8, wherein the pause phoneme inserter inserts the at least one pause phoneme into the plurality of phonemes by further performing steps of:
determining a pause position of a pause phoneme of the at least one pause phoneme according to a length of a buffer memory; and
inserting the pause phoneme to the pause position.

11. The text-to-speech system according to claim 8, wherein the pause phoneme inserter inserts the at least one pause phoneme into the plurality of phonemes by further performing steps of:
determining whether the text series comprises a phrase; and
when the text series comprises the phrase, inserting a pause phoneme of the at least one pause phoneme to a corresponding end of the phrase.

12. The text-to-speech system according to claim 8, wherein the phoneme generator further performs a step of:
inserting a punctuation into the text series.

13. The text-to-speech system according to claim 7, further comprising:
a speech synthesizer, performing a speech synthesis operation individually on the plurality of speech segments to generate a plurality of speech outputs corresponding to the speech segments.

14. The text-to-speech system according to claim 13, wherein the speech synthesizer comprises:
an acoustic parameter generator, generating a plurality of excitation parameters and a plurality of spectral parameters according to a first speech segment of the plurality of speech segments;
an excitation signal generator, generating a plurality of excitation signals according to the plurality of excitation parameters; and
a synthesis filter, generating a first speech output corresponding to the first speech segment according to the plurality of excitation signals and the plurality of spectral parameters.

15. A text-to-speech system, comprising:
a processing circuit; and
a storage circuit, coupled to the processing circuit, storing a program code, the program code instructing the processing circuit to perform steps of:
receiving a text series, and generating a plurality of phonemes corresponding to the text series, wherein the plurality of phonemes form a phoneme series;
inserting at least one pause phoneme into the phoneme series; and
dividing the phoneme series and the at least one pause phoneme into a plurality of phoneme sub-series, and generating a plurality of speech segments by using the at least one pause phoneme as a dividing point, wherein each of the speech segments comprises a plurality of text labels that comprise relationships of the plurality of phonemes;
wherein, the at least one pause phoneme is a last phoneme of the phoneme sub-series in which the at least one pause phoneme locates.

16. The text-to-speech system according to claim 15, wherein the program code instructs the processing circuit to insert the at least one pause phoneme into the phoneme series by further instructing the processing circuit to perform a step of:
inserting a pause phoneme of the at least one pause phoneme at a corresponding punctuation of the text series.

17. The text-to-speech system according to claim 15, wherein the program code instructs the processing circuit to insert the at least one pause phoneme into the phoneme series by further instructing the processing circuit to perform steps of:
determining a pause position of a pause phoneme of the at least one pause phoneme according to a length of a buffer memory; and
inserting the pause phoneme to the pause position.

18. The text-to-speech system according to claim 15, wherein the program code instructs the processing circuit to insert the at least one pause phoneme into the phoneme series by further instructing the processing circuit to perform steps of:
determining whether the text series comprises a phrase; and
when the text series comprises the phrase, inserting a pause phoneme of the at least one pause phoneme to a corresponding end of the phrase.

19. The text-to-speech system according to claim 15, wherein the program code further instructs the processing circuit to perform a step of:
inserting a punctuation into the text series.

20. The text-to-speech system according to claim 15, wherein the program code further instructs the processing circuit to perform a step of:
performing a speech synthesis operation individually on the plurality of speech segments to generate a plurality of speech outputs corresponding to the speech segments.

21. The text-to-speech system according to claim 20, wherein the program code instructs the processing circuit to perform the speech synthesis operation individually on a first speech segment of the plurality of speech segments to generate a first speech output corresponding to the first speech segment by further instructing the processing circuit to perform steps of:
generating at least one excitation parameter and at least one spectral parameter according to the first speech segment;
generating at least one excitation signal according to the at least one excitation parameter; and
generating the first speech output corresponding to the first speech segment according to the at least one excitation signal and the at least one spectral parameter.
